(19) United States
(12) Patent Application Publication
(10) Pub. No.: US 2012/0096226 A1
(43) Pub. Date: Apr. 19, 2012

(54) TWO LEVEL REPLACEMENT SCHEME OPTIMIZES FOR PERFORMANCE, POWER, AND AREA

(76) Inventors: Stephen P. Thompson, Longmont, CO (US); Robert Krick, Longmont, CO (US); Tarun Nakra, Austin, TX (US)

(21) Appl. No.: 12/906,936

(22) Filed: Oct. 18, 2010

(51) Int. Cl. G06F 12/08; G06F 12/00

(52) U.S. Cl. 711/136; 711/133; 711/E12.001; 711/E12.022

(57) ABSTRACT

A two-level replacement scheme is provided for selecting an entry in a cache memory to replace when a cache miss takes place and the memory is full. The scheme divides the tags associated with each memory location of the cache into two or more groups, each group relating to a subset of memory locations of the cache. The scheme uses a first algorithm to select one of the groups and passes the tags for the group through a second algorithm. The second algorithm produces a local index which, when combined with a group index, produces a replacement index that identifies a memory location in the cache to replace.

### BACKGROUND OF THE INVENTION

1. Field of the Invention

The present disclosure relates, generally, to systems using associative cache memories and translation look-aside buffers (TLBs) and, specifically, to circuits and processes for selecting an entry thereof for replacement.

2. Description of the Related Art

In many computer systems, an associative cache memory sits between the processor and the main memory. The cache memory provides the processor immediate access to a limited amount of frequently used information, has a limited number of entries, and may store program instructions or data. When the processor accesses the information in the cache memory, it typically checks tags and validity bits to determine whether the memory contains valid information. If the cache contains valid information that the processor is requesting, it is supplied directly to the processor. If the cache does not contain valid information the processor is requesting, the processor must retrieve the information from elsewhere, such as from main memory.

Accesses to main memory can be costly. Unlike some cache memories, main memory is typically external to the processor, is slower, requires more access time, and is further limited in its speed of access by its physical location away from the processor. Moreover, accesses to main memory typically require translating virtual memory addresses into physical memory addresses by, for example, accessing offsets in the main memory and computing the physical addresses from the offsets. In many computer systems today, there may be several layers of such offsets, such as one layer for each layer of cache memory.

To make main memory accesses more efficient, computer systems typically utilize a translation look-aside buffer (TLB). A TLB is a type of cache memory. It converts virtual addresses into physical addresses. When a processor requires a physical address, it sends the corresponding virtual address to the TLB. If the TLB contains a valid entry associated with the virtual address, it returns the corresponding physical address. The processor then uses the physical address to obtain the desired information. If a valid entry is not found in the TLB, a cache miss occurs, and the processor must calculate the physical address of main memory by, for example, accessing offsets therein. Like other cache memories, a TLB has a limited number of entries. A typical range is from 32 to 64.

Computer systems employing memory caches and TLBs store the most recent accesses to main memory in the respective caches for future reference. When the memory cache or TLB becomes full, older entries must be overwritten. Computer systems utilize a variety of algorithms or policies to determine which entry should be overwritten when the memory cache or TLB becomes full. The goal of these algorithms or policies is to minimize the number of future cache misses by overwriting entries that are least useful.

One such policy is called Least Recently Used (LRU). This policy seeks to replace the entry that was least recently accessed in the memory cache or TLB with the newest one. One theory behind replacing the LRU entry is that the entry may no longer be needed because, for example, the program that used the entry may no longer be executing. To implement this policy, computer systems must monitor the access of each entry in the respective cache memories and determine which one is the least recently used. Implementing a fully accurate LRU policy turns out to be rather complex. When implemented in a microcircuit design, it requires a relatively larger number of components, chip area, and power consumption than, for example, other algorithms or policies, such as a round robin or pseudo-LRU algorithm or policy, though it may achieve better performance. Other algorithms known in the art include random, FIFO, or least frequently used (LFU).

### SUMMARY OF EMBODIMENTS OF THE INVENTION

The apparatuses, systems, and methods in accordance with the embodiments of the present invention combine at least two replacement policies or algorithms to achieve greater efficiencies without sacrificing significant performance. One such embodiment of the invention, for example, divides the tags associated with each memory location of a cache into two or more groups, where each group contains replacement information related to a subset of the memory locations inside the cache. The embodiment uses a first selection algorithm, such as a round-robin algorithm, to select one of the groups and produces a group selection index identifying that group. It then passes the tags for that group to a second algorithm, such as a 3-bit pseudo-LRU, which produces a local index that identifies which memory location associated with that group to replace. The two indexes combine to form a replacement index that fully identifies one memory location of the cache to replace.

For example, a memory cache or TLB having a total of forty entries can be divided into 10 sets of four entries. Tags related to each entry may then be divided into 10 sets or groups, each group relating to just four entries of the cache. A first replacement policy, such as a round-robin policy, may be used to select one of the 10 groups of tags to examine, and a second replacement policy may then determine which of the entries to replace based on the tags for that group. The second replacement policy may be, for example, a 3-bit pseudo-LRU policy. When implemented in a microcircuit design, fewer combinational gates are needed to implement the scheme than, for example, a pseudo-LRU policy alone, because the combinational logic connecting the tag memory elements uses fewer gates and is simpler to implement. Such a design provides an acceptable level of performance with respect to cache misses while reducing the corresponding chip area and power consumption of the device.

One apparatus in accordance with an exemplary embodiment of the invention comprises a set of memory elements for storing the tags, wherein the memory elements are configured into two or more groups, each group associated with a subset of memory locations of a cache memory and capable of storing replacement information related to the subset. The apparatus further comprises a group selector configured to select one of the groups of memory elements and producing a group index identifying the subset of memory locations that are candidates for replacement. The apparatus further comprises an index generator configured to produce a local index from the replacement information stored in the memory elements of the selected group. The local index and group index, when combined, form a replacement index that identifies one memory location in the cache memory to replace. The cache memory may be, for example, a TLB.

One embodiment of the group selector may be a modulo-10 round robin counter that connects to a first multiplexer configured to select one group of three bits and to supply that group of three bits to a 3-bit pseudo-LRU device. The output of the counter produces a group index that identifies which of the ten groups of three bits was selected. The 3-bit pseudo-LRU device may be designed with a simple multiplexer that utilizes the three bits to produce an LRU index. The group index and the LRU, or local, index can be combined to select one memory location of a cache memory to replace.

One method in accordance with one embodiment of the invention comprises selecting one of a plurality of groups of memory elements utilizing a first algorithm, wherein the memory elements of each group are associated with a subset of memory locations of a cache memory and capable of storing replacement information related to the subset of memory locations, determining from the selected group of memory elements a local index utilizing a second algorithm, and generating a replacement index from the local index and the group selected. The replacement index can be used to select which memory location in the cache memory to replace. The cache memory may be a TLB. The first algorithm may be selected from the group consisting of a round-robin, first-in first-out, or random selection algorithm, for example, and the second algorithm may be selected from the group consisting of a simplified LRU algorithm, a 3-bit pseudo-LRU algorithm, and a LFU algorithm. Other combinations may apply.

The structures of the apparatus may be formed on a semiconductor material, such as by growing or deposition, or by any other method. The invention may also be embodied in software by implementing the combinations of algorithms identified herein and applying them to a cache memory. The microcircuit design may also be rendered in a computer readable format using a hardware descriptive language, such as VHDL and Verilog/Verilog-XL, for manufacture in a fabrication facility.

### BRIEF DESCRIPTION OF THE FIGURES

The disclosed subject matter will hereafter be described with reference to the accompanying drawings, wherein like reference numerals denote like elements, and:

FIG. 1 is a simplified block diagram of a two-level replacement scheme in accordance with an exemplary embodiment of the invention.

FIG. 2 is a simplified logic block diagram illustrating one implementation of a 3-bit pseudo-LRU algorithm in accordance with an exemplary embodiment of the invention.

FIG. 3 is a diagram illustrating one possible set of tag bit values that can be associated with one implementation of a 3-bit pseudo-LRU algorithm in accordance with an exemplary embodiment of the invention.

FIG. 4 is a diagram further illustrating the meaning of the tag bit values for the exemplary embodiment illustrated in FIG. 3.

FIG. 5 is a simplified diagram of a linear feedback shift register in accordance with an exemplary embodiment of the invention.

FIG. 6 is a state diagram illustrating the outputs of the linear feedback shift register of FIG. 5 in accordance with an exemplary embodiment of the invention

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the disclosed subject matter as defined by the appended claims.

### DETAILED DESCRIPTION

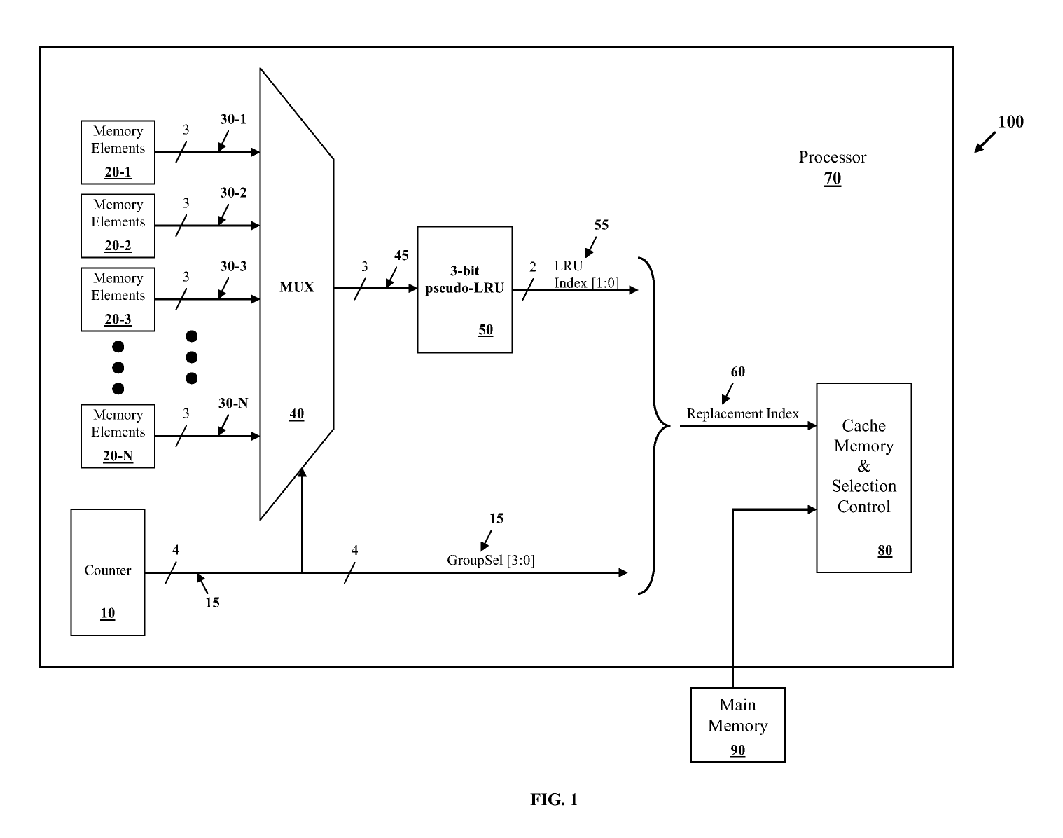

FIG. 1 is a simplified block diagram of a two-level replacement scheme in accordance with an exemplary embodiment of the invention. A counter 10 connects to a multiplexer 40 to select one (e.g., 30-1) of a number of groups of memory elements (30-1 to 30-N) to be applied to, for example, a 3-bit pseudo-LRU 50 algorithm. As shown, counter 10 is a four bit counter capable of selecting one of sixteen different groups of 3-bit memory elements 20. The memory elements 20 can be three flip flops, a memory having three bits, or any other suitable memory element for storing three bits. In another embodiment, the counter 10 may be a modulo-10 counter that, for example, selects one of ten groups of 3-bit memory elements. Each group of memory elements (30-1 to 30-N) stores information, such as a 3-bit pseudo-LRU tag, that comprises replacement information for a subset of the memory locations of a cache memory 80. A cache memory 80 having forty entries, for example, may be divided into ten groups of four entries, where each group of four entries is associated with one group of 3-bit memory elements 30. Each group of 3-bit memory elements 30 stores replacement information, such as one 3-bit pseudo-LRU tag, for its associated group of memory locations.

In the exemplary embodiment, the tag bits are stored in memory elements 30. When a cache miss occurs, counter 10 selects one of the groups of 3-bit memory elements, such as 30-2, to apply to the 3-bit pseudo-LRU algorithm 50. The counter 10 in combination with multiplexer 40 implement a round-robin group selector, as the counter can be configured to increment upon each replacement of a memory location in the cache memory 80 so as to select the next group. The output of the counter produces a group selection index, e.g., GroupSel [3:0] 15. The group selected determines which subset of four cache memory locations are candidates for replacement. When the associated tags for the group are passed through the 3-bit pseudo-LRU 50 algorithm, the 3-bit pseudo-LRU algorithm identifies which of the four candidates is the least recently used from the tag elements of the group. In one embodiment described in detail below, the 3-bit pseudo-LRU algorithm produces a local index, e.g., LRU index 55, for identifying which of the four memory locations is the least recently used. The local index 55, when combined with the group index 15, creates a replacement index 60 that uniquely identifies one of the forty entries in the cache memory 80 to replace. The round-robin selector and the 3-bit pseudo-LRU algorithm form one embodiment of a two-level replacement scheme. Other embodiments include mixing and matching different replacement schemes, such as by replacing the round-robin selector with a random selector or a first-in, first-out selector, and the 3-bit pseudo-LRU algorithm with a least frequently used (LFU) algorithm, a fully implemented LRU, or another simplified LRU algorithm.

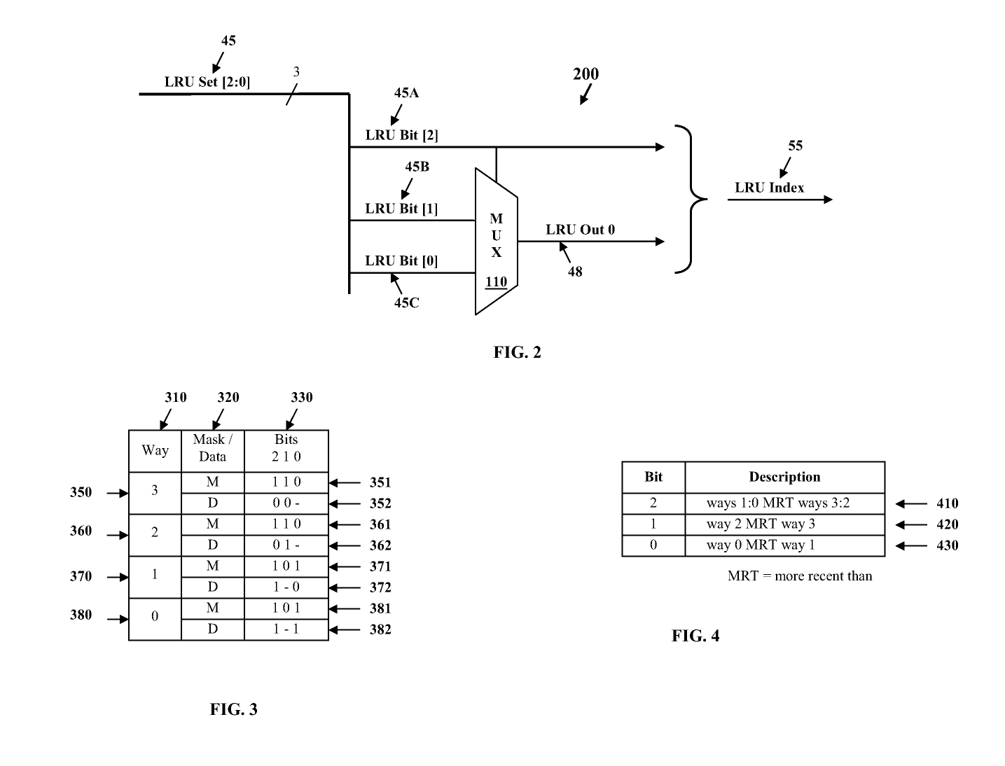

One embodiment of the 3-bit pseudo-LRU 50 algorithm is shown in FIG. 2 and discussed in relation to FIG. 3 and FIG. 4. FIG. 3 shows the data (D) values (352, 362, 372, and 382, respectively) used by the 3-bit pseudo-LRU 50 to select the least recently used memory location of a group, and FIG. 4 illustrates their meaning The data values are the three tag bits that are stored in the 3-bit memory elements, e.g., 30-1, when a cache memory location associated with the group has been inserted or replaced. A dash in the figure represents a “don't care” value because certain bits are masked when the data is written, as discussed in more detail below. Ways 0 to 3 (shown by 380, 370, 360, and 350, respectively) represent the four memory locations of a cache memory associated with one group. When a cache memory location represented by the group is inserted or replaced, that location becomes the most recently used (MRU) until a subsequent memory location represented by the group is inserted or replaced.

For example, if the memory location represented by Way 3 350 is the most recently used or replaced for the group, then Way 3 350 is, by definition, more recent than Way 2 360, and the combination of memory locations represented by Way 3 350 and Way 2 360 are more recent than the combination of memory locations represented by Way 1 370 and Way 0 380. These definitions are reflected by the bit descriptions illustrated in FIG. 4.

Per FIG. 4, Bit 2 410 of the 3-bit tag bits stored in each group of 3-bit memory elements determines which of the two combinations of ways (i.e. Ways 1:0 or Ways 3:2) is more recent, while Bits 1 420 and 0 430 determine whether Way 2 is more recent than Way 3 and whether Way 0 is more recent than Way 1, respectively. The bit values represented by 352 are written into the respective tag memory elements when the memory location associated with Way 3 350 is the most recent. When writing these bits, mask value 351 is used. Bit 0 is masked because it is a “don't care.” It is a “don't care” because the meaning of Bit 0 determines only whether Way 0 is more recent than Way 1, and that relationship is not affected by an update to the memory location associated with Way 3. Moreover, masking out Bit 0 is required to preserve the relationship between Way 0 and Way 1, which may have been decided by a previous update to one of those associated memory locations.

Referring again to FIG. 4, a logic zero written to Bit 2 means, logically, that it is not true that Ways 1 and 0 are more recent than Ways 3 and 2, and a logic zero written to Bit 1 means, logically, that it is not true that Way 2 is more recent than Way 3. Following further with the example, if the memory location represented by Way 1 370 is updated next, then the data and mask values shown by 372 and 371, respectively, would be used to update to the respective tag bits stored in the 3-bit memory elements for the group. Consequently, a logic one is written to Bit 2, a logic zero is written to Bit 0, and Bit 1 remains unmodified, because the replacement of the memory location associated with Way 1 has no logical effect on whether Way 2 is more recent than Way 3. Per the example, the bit values for the group now become 1-0-0, following the second update. These bit values comprise the LRU Set [2:0] 45, shown in FIG. 2, when the group is subsequently selected for replacement by the round-robin group selector.

If a replacement is needed and the group is subsequently selected, then the bit values 1-0-0 will appear on multiplexer 110, as shown in FIG. 2. A logic one on LRU Bit [2] 45A causes LRU Bit[1] 45B to appear as LRU Out 0 48, which, in the example, is a logic zero. LRU Index 55 is the combination of LRU Bit [2] and LRU Out 0 48, which becomes a 1-0 in the example. LRU Set [2], when a logic one, means that the Ways 1:0 are more recent than Ways 3:2 (410), or, stated differently, Ways 3:2 are least recently used than Ways 1:0. A logic zero on LRU Set [1] means that Way 2 is not more recent than Way 3 (420), meaning that Way 2 is least recently used than Way 3. Consequently, the LRU index 55 indicates that the memory location associated with Way 2 is the least recently used. The actual memory location that is replaced is the least recently used memory location associated with the selected group. This is determined by the replacement index 60, which is formed from the combination of the group index 15 and the LRU index 55.

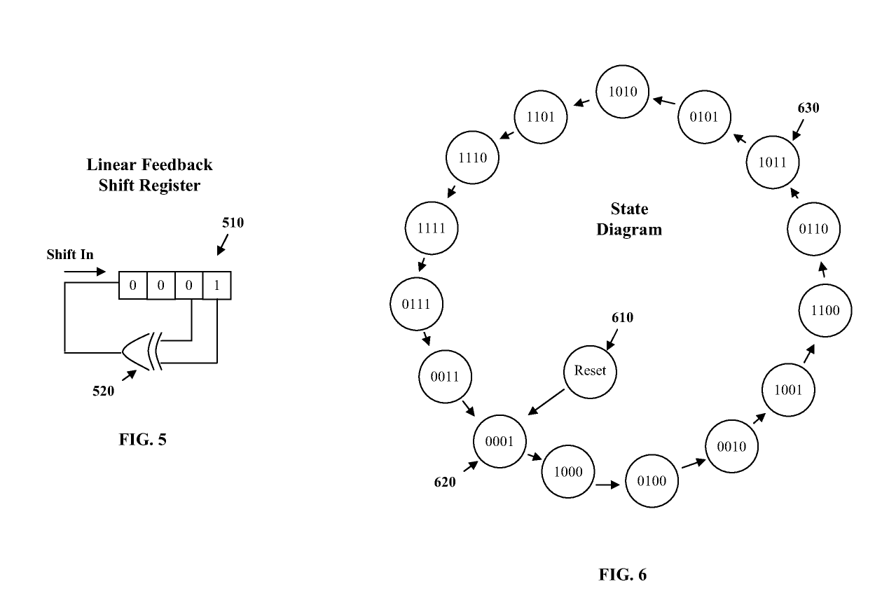

FIG. 5 shows an exemplary embodiment of a linear feedback shift register 510 that can be used, for example, to randomly select one of fifteen groups of memory elements. The circuit comprises a 4-bit shift register 510 connected to an exclusive-OR gate 520. The exclusive-OR gate provides feedback to the input of the shift register. FIG. 6 shows the contents of the shift register 510 with each successive clock pulse of a free running clock (not shown) supplied to the shift register. The shift register is initialized to a known state 620 after, for example, a power-on reset or a cache flush 610. Once initialized, the free running clock cycles the contents of the shift register 510 according to the diagram shown in FIG. 6. If a cache miss occurs, the output of the feedback register can be read and used to select one of the fifteen groups of memory elements. The selection is random because the clock is free running and the shift register may be read at any time. By subtracting one from the value read from the shift register, the values can range from zero to fourteen. Alternatively, a free running counter could be used instead of a linear feedback shift register and configured, for example, as a modulo-10 counter to select one of ten values.

To implement a least frequently used algorithm, an 8-bit counter, for example, can be assigned to each memory location of each group and incremented with each access of the respective memory location. When one of the counters of a group reaches a maximum count, the contents of the counters in each group can be adjusted by, for example, shifting the contents of the counters in a manner that shifts out the least significant bit and shifts a zero into the most significant bit. This preserves the relative count between each location of the group. When a cache miss occurs, comparators may compare the outputs of each counter and select which memory location has the least number of accesses. In the example above where each group has four cache memory locations associated with it, there can be a upper comparator that compares the counter values for the upper two memory locations and a lower comparator that compares the counter values for the two lower ones. The least frequently used value of each may be multiplexed to a third comparator to select between the remaining two. If any two values supplied to any comparator are equal, a flip-flop can be used to arbitrarily select between the two values and toggled to select the other value the next time the two values are equal to ensure a fair distribution between the values.

A FIFO group selection scheme may be implemented, for example, with the linear feedback shift register shown in FIG. 5. In this embodiment, the shift register is not tied to a free running clock. Rather, it is incremented each time a cache miss occurs. The output of the shift register is used as a group index. When a cache miss occurs, the index is read and then incremented to its next value. Because the values repeat themselves in the order shown in FIG. 6, the replacement scheme operates as a FIFO algorithm to select one of fifteen groups of memory locations. To select fewer than fifteen groups, for example eight groups, the linear feedback shift register 510 may be reset to its initial state once the value at 630 is, for example, read. The output of the shift register can be converted to a value between zero and seven to select one of eight groups.

As understood by one of ordinary skill in the art, invalid entries in a cache memory are typically replaced before valid ones. For example, after a power-on reset or a cache flush, all values in a cache memory typically become invalid. When a cache miss occurs, tag bits are consulted to identify and replace invalid entries first. Once all memory locations in a cache memory contain valid entries, the replacement scheme, like the two-level replacement scheme described above, selects which of the valid entries to replace. A subsequent reset or cache flush returns the device and the replacement scheme to its initial conditions. Once all of the invalid entries are again identified and replaced, the replacement scheme again operates to select which of the valid entries to replace.

The hardware structures in accordance with the embodiments described herein may be formed on a semiconductor material by any known means in the art. Forming can be done, for example, by growing or deposition, or by any other means known in the art. Different kinds of hardware descriptive languages (HDL) may be used in the process of designing and manufacturing microcircuit devices. Examples include VHDL and Verilog/Verilog-XL. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in one embodiment, may be used to configure a manufacturing facility (e.g., through the use of mask works) to create devices capable of embodying various aspects of the instant invention. As understood by one of ordinary skill in the art, it may be programmed into a computer, processor or controller, which may then control, in whole or part, the operation of a semiconductor manufacturing facility (or fab) to create semiconductor products and devices. These tools may be used to construct the embodiments of the invention described herein.

Though the two-tiered hierarchical system was described in terms of hardware components, the invention may be implemented in software, firmware, or any other structural mechanism using corresponding components. Moreover, the invention is not limited to groups of memory elements having only three bits, a 3-bit pseudo-LRU implementation, a round-robin group selection method, or a round-robin group selection method comprising a counter and a multiplexer. As described above, other structures and algorithms may be used or implemented; the structures and algorithms are well known in the art.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

We claim:

1. A method of selecting an entry in a cache memory for replacement, comprising:
selecting one of a plurality of groups of memory elements utilizing a first algorithm, wherein the memory elements of each group are associated with a subset of memory locations of a cache memory and capable of storing replacement information related thereto;
determining from the selected group of memory elements a local index utilizing a second algorithm; and
generating a replacement index from the local index and the selected group for selecting a memory location in the cache memory to replace.

2. The method of claim 1, wherein the first algorithm is selected from the group consisting of a round-robin, first-in first-out, and random selection algorithm, and the second algorithm is selected from the group consisting of a least recently used (LRU) and least frequently used (LFU) algorithm.

3. The method of claim 1, wherein the first algorithm is a round-robin algorithm and the second algorithm is a pseudo-LRU algorithm.

4. The method of claim 3, wherein the pseudo-LRU algorithm comprises at least three bits.

5. The method of claim 4, wherein the round-robin algorithm is implemented using at least one counter and at least one multiplexer.

6. The method of claim 5, wherein the cache memory is a translation look-aside buffer (TLB).

7. An apparatus comprising:
a set of memory elements configured into two or more groups, each group associated with a subset of memory locations of a cache memory and capable of storing replacement information related to the subset;
a group selector coupled to the memory elements and configured to select one of the groups and to produce a group index related to the subset of memory locations associated with the group; and
an index generator coupled to the group selector and configured to produce a local index from the replacement information stored in the memory elements of the selected group, wherein the local index and the group index are configured to identify a memory location in the cache memory for replacement.

8. The apparatus of claim 7, wherein the group selector implements an algorithm selected from the group consisting of a round-robin, first-in first-out, and random selection algorithm, and the index generator implements an algorithm selected from the group consisting of a LRU and a LFU algorithm.

9. The apparatus of claim 7, wherein the group selector comprises at least one counter and at least one multiplexer and the index generator implements a pseudo-LRU algorithm.

10. The apparatus of claim 9, wherein the index generator comprises a multiplexer.

11. The apparatus of claim 10, wherein the cache memory is a TLB.

12. The apparatus of claim 7, further comprising a microprocessor, the microprocessor comprising the cache memory and configured to replace the contents of the memory location identified by the local and group indexes.

13. A computer readable storage device encoded with data that, when implemented in a manufacturing facility, adapts the manufacturing facility to create an apparatus, comprising:
a set of memory elements configured into two or more groups, each group associated with a subset of memory locations of a cache memory and capable of storing replacement information related to the subset;
a group selector coupled to the memory elements and configured to select one of the groups and to produce a group index related to the subset of memory locations associated with the group; and
an index generator coupled to the group selector and configured to produce a local index from the replacement information stored in the memory elements of the selected group, wherein the local index and the group index are configured to identify a memory location in the cache memory for replacement.

14. The computer readable storage device of claim 13, wherein the group selector comprises at least one counter and at least one multiplexer and the index generator implements a pseudo-LRU algorithm.

15. The computer readable storage device of claim 14, wherein the index generator comprises a multiplexer.

16. The computer readable storage device of claim 15, wherein the cache memory is a TLB.

17. The computer readable storage device of claim 13, wherein the apparatus further comprises a microprocessor, the microprocessor comprising the cache memory and wherein the microprocessor is configured to replace the contents of the memory location identified by the local and group indexes.

18. A method of selecting an entry in a cache memory for replacement, comprising:
forming a set of memory elements on a semiconductor material, the memory elements being configured into two or more groups, each group associated with a subset of memory locations of a cache memory and capable of storing replacement information related to the subset;
forming a group selector on the semiconductor material coupled to the memory elements and configured to select one of the groups and to produce a group index related to the subset of memory locations associated with the group; and
forming an index generator on the semiconductor material coupled to the group selector and configured to produce a local index from the replacement information stored in the memory elements of the selected group, wherein the local index and the group index are configured to identify a memory location in the cache memory to replace.

19. The method of claim 18, wherein the group selector comprises at least one counter and at least one multiplexer.

20. The apparatus of claim 19, wherein the index generator implements a pseudo-LRU algorithm.

21. The apparatus of claim 20, wherein the index generator comprises a multiplexer.

22. The apparatus of claim 18, wherein the cache memory is a TLB.
